(19) United States
(12) Patent Application Publication
(10) Pub. No.: US 2025/0391082 A1
(43) Pub. Date: Dec. 25, 2025

(54) AUGMENTED REALITY SYSTEMS AND METHODS FOR PERFORMING VIRTUAL FITTING OF EYEWEAR

(71) Applicant: Perfect Mobile Corp., New Taipei City (TW)

(72) Inventors: Chieh LEE, Taoyuan City (TW); Yi-Hsin LIU, Taipei City (TW)

(21) Appl. No.: 19/229,641

(22) Filed: Jun. 5, 2025

Related U.S. Application Data
(60) Provisional application No. 63/663,341, filed on Jun. 24, 2024.

(51) Int. Cl. G06T 13/40; G06F 3/01; G06T 11/60; G06V 40/16

(52) U.S. Cl. CPC G06T 13/40; G06F 3/012; G06T 11/60; G06V 40/176

(57) ABSTRACT

A computing device obtains a first image depicting a facial region of a user and an object occluding a portion of the facial region of the user. The computing device generates a second image of the user without the object occluding the portion of the facial region of the user based on the first image. A selection comprising desired eyeglasses is obtained, and the computing device generates a third image comprising the desired eyeglasses rendered on the second image to perform virtual try-on of the desired eyeglasses for the user to evaluate.

### CROSS-REFERENCE TO RELATED APPLICATION

This application claims priority to, and the benefit of, U.S. Provisional Patent Application entitled, “System and Method for Eyeglasses Virtual Try On,” having Ser. No. 63/663,341, filed on Jun. 24, 2024, which is incorporated by reference in its entirety.

### TECHNICAL FIELD

The present disclosure generally relates to systems and methods for allowing users to experience virtual application of eyeglasses.

### SUMMARY

In accordance with one embodiment, a computing device obtains a first image depicting a facial region of a user and an object occluding a portion of the facial region of the user. The computing device generates a second image of the user without the object occluding the portion of the facial region of the user based on the first image. The computing device obtains a selection comprising desired eyeglasses and generates a third image comprising the desired eyeglasses rendered on the second image to perform virtual try-on of the desired eyeglasses.

In accordance with another embodiment, a computing device obtains a live video. The computing device obtains a first frame from the live video, the first frame depicting a facial region of a user and an object occluding a portion of the facial region of the user. The computing device generates a first image of the user without the object occluding the portion of the facial region of the user based on the first frame. The computing device generates a first three-dimensional (3D) avatar of the user using an artificial intelligence (AI) model based on the first image. The computing device obtains a selection comprising desired eyeglasses and merges the desired eyeglasses and the first 3D avatar to generate a second 3D avatar. In frames subsequent to the first frame of the live video, the computing device tracks a pose of head of the user, transforms the second 3D avatar to depict the pose of the head, and displays the second 3D avatar.

In accordance with another embodiment, a computing device obtains a live video. The computing device obtains a first frame from the live video, the first frame depicting a facial region of a user. The computing device generates a three-dimensional (3D) avatar of the user using an artificial intelligence (AI) model based on the first frame. The computing device obtains a selection comprising desired eyeglasses. In frames subsequent to the first frame of the live video, the computing device tracks a pose of a head of the user, transforms the 3D avatar and the desired eyeglasses to depict the pose of the head, and displays the 3D avatar and the desired eyeglasses.

Another embodiment is a system that comprises a memory storing instructions and a processor coupled to the memory. The processor is configured by the instructions to obtain a live video. The processor is further configured to obtain a first frame from the live video, the first frame depicting a facial region of a user and an object occluding a portion of the facial region of the user. The processor is further configured to generate a first image of the user without the object occluding the portion of the facial region of the user based on the first frame. The processor is further configured to generate a first three-dimensional (3D) avatar of the user using an artificial intelligence (AI) model based on the first image. The processor is further configured to obtain a selection comprising desired eyeglasses and merge the desired eyeglasses and the first 3D avatar to generate a second 3D avatar. In frames subsequent to the first frame of the live video, the processor is further configured to track a pose of head of the user, transform the second 3D avatar to depict the pose of the head, and display the second 3D avatar.

Another embodiment is a non-transitory computer-readable storage medium storing instructions to be implemented by a computing device. The computing device comprises a processor, wherein the instructions, when executed by the processor, cause the computing device to obtain a live video. The processor is further configured by the instructions to obtain a first frame from the live video, the first frame depicting a facial region of a user and an object occluding a portion of the facial region of the user. The processor is further configured by the instructions to generate a first image of the user without the object occluding the portion of the facial region of the user based on the first frame. The processor is further configured by the instructions to generate a first three-dimensional (3D) avatar of the user using an artificial intelligence (AI) model based on the first image. The processor is further configured by the instructions to obtain a selection comprising desired eyeglasses and merge the desired eyeglasses and the first 3D avatar to generate a second 3D avatar. In frames subsequent to the first frame of the live video, the processor is further configured by the instructions to track a pose of head of the user, transform the second 3D avatar to depict the pose of the head, and display the second 3D avatar.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to implement an augmented reality service for performing virtual fitting of eyewear according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for implementing an augmented reality service for performing virtual fitting of eyewear according to various embodiments of the present disclosure.

FIG. 4 illustrates an example user interface provided on a display of the computing device according to various embodiments of the present disclosure.

FIG. 5 illustrates the computing device of FIG. 1 performing image enhancement on a sample image according to various embodiments of the present disclosure.

FIG. 6 illustrates the computing device of FIG. 1 processing a target image, whereby an occlusion is removed and desired eyewear is then rendered on the modified target image according to various embodiments of the present disclosure.

FIG. 7 illustrates the computing device of FIG. 1 rendering a processed image with the selected eyewear superimposed on the facial region of an avatar of the user according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

Embodiments are disclosed for implementing an augmented reality experience for performing virtual fitting of desired eyewear on an image of a user, independent of whether the image depicts eyewear or other occlusions on the facial region of the user. One perceived shortcoming of conventional augmented reality services is that users are typically required to remove their glasses in order for conventional systems to accurately display virtual eyewear on the facial region of the user. However, this can present problems for users who are nearsighted or have other vision impairments that require corrective eyewear when evaluating the virtual eyewear. Embodiments of the improved augmented reality systems and methods disclosed herein allow users to keep their glasses on while undergoing virtual fitting of eyewear of interest, thereby allowing the user to view the eyewear of interest in an augmented reality setting without having their eye sight hindered.

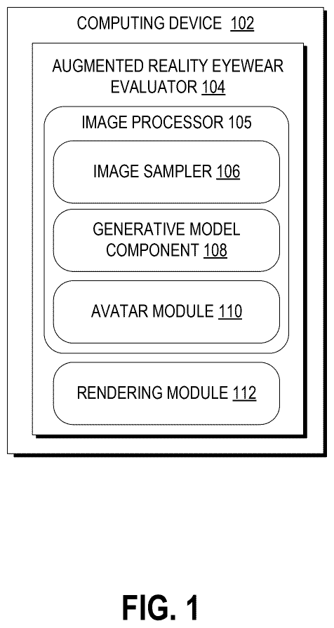

A description of a system for implementing an augmented reality service for performing virtual fitting of desired eyewear is described followed by a discussion of the operation of the components within the system. FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

An augmented reality eyewear evaluator 104 executes on a processor of the computing device 102 and includes an image processor 105 configured to receive a target image of a user and generate a modified image where any occlusions on the facial region of the user depicted in the target image are removed. For various embodiments, the image processor 105 utilizes an artificial intelligence (AI) generative model comprising a diffusion model for generating images, videos, and so on. The diffusion model generates new images by denoising random noise introduced to sample images. To train the diffusion model, the image processor 105 receives sample images of the user and expands dataset diversity of the sample images by performing image enhancement portions of the sample images. This allows the image processor 105 to generate other sample images similar to sample images on which the image processor 105 is trained.

The image processor 105 comprises an image sampler 106, a generative model component 108, and an avatar module 110. The augmented reality eyewear evaluator 104 further comprises a rendering module 112. The augmented reality eyewear evaluator 104 is further configured to obtain user input specifying desired eyewear that the user wishes to evaluate. The image sampler 106 is configured to obtain a target image of a user's facial region and display the user's face on a display of the computing device 102. The selected eyewear is later rendered on the user's face depicted in the target image on the display. Note that the user is not required to provide an unobstructed view of the user's face. For example, the user is not required to remove any eyewear being worn by the user.

The computing device 102 may be equipped with the capability to connect to the Internet, and the image sampler 106 may be configured to obtain an image or video of the user from another device or server. The images obtained by the image sampler 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The video may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

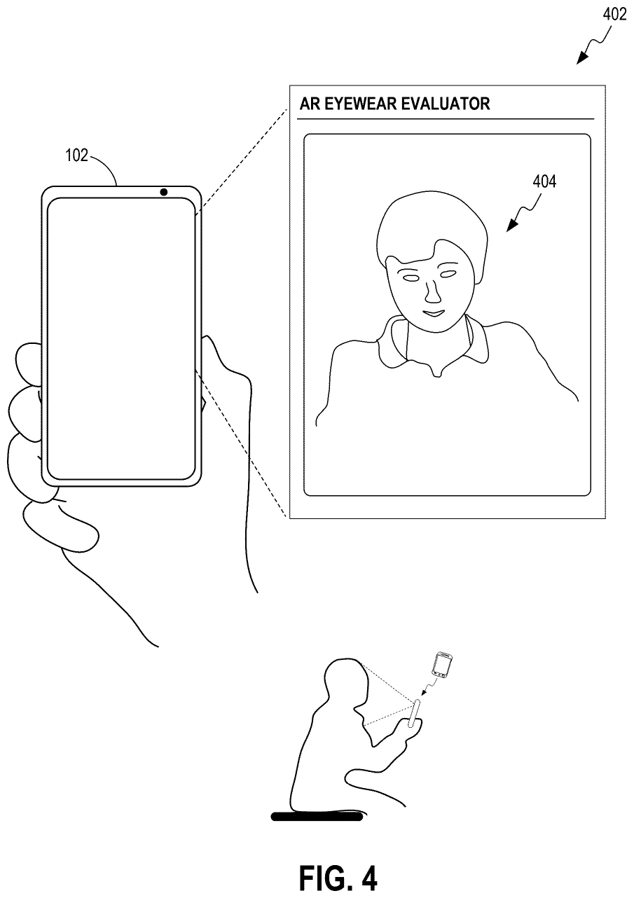

FIG. 4 illustrates an example user interface 402 provided on a display of the computing device 102 whereby an image of the user's face 404 is captured and displayed to the user. For some implementations, the image sampler 106 (FIG. 1) executing in the computing device 102 may be configured to cause a front-facing camera of the computing device 102 to capture an image or a video of a user's face 404. The computing device 102 may also be equipped with the capability to connect to the Internet, and the image sampler 106 may be configured to obtain an image or video of the user from another device or server.

Referring back to FIG. 1, the image sampler 106 is configured to accumulate sample images of the user's face, preferably where some of the sample images depict occlusions on the facial region of the user while other sample images do not depict any occlusions on the facial region of the user. For instances where the image sampler 106 is unable to obtain any sample images depicting occlusions on the facial region of the user, the image sampler 106 performs image enhancement on a portion of the sample images whereby occlusions are inserted into the sample images. Such occlusions may comprise, for example, eyewear and/or other objects (e.g., hand) superimposed on the facial region of the user. The image enhancement operation is not limited to insertion of occlusions into the sample images. Other image enhancement operations include rotating the facial region of the user, performing translation on the facial region of the user, scaling the facial region of the user, and so on.

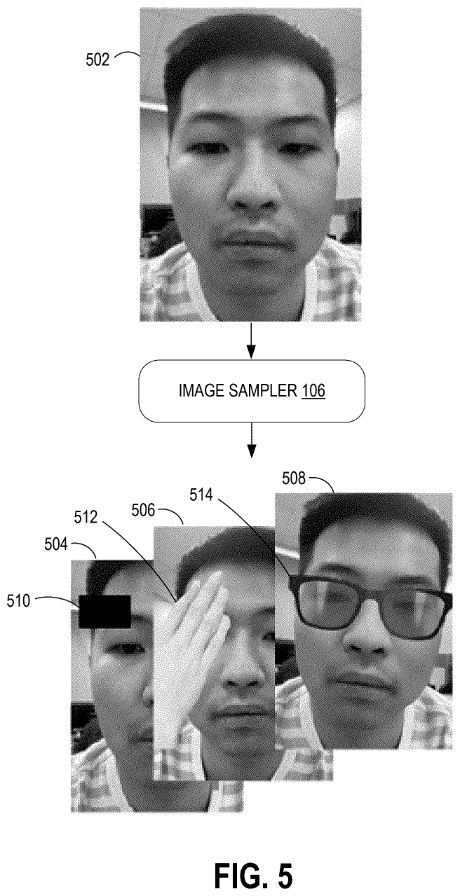

FIG. 5 illustrates an example of the image sampler 106 performing image enhancement on a sample image 502 used for training purposes. In the example shown, the image sampler 106 obtains a sample image 502 where no occlusion is present on the facial region of the user. To expand dataset diversity of the sample images 502, the image sampler 106 generates additional sample images 504, 506, 508, whereby different occlusions 510, 512, 514 are inserted into the sample images 504, 506, 508. Increasing the volume of sample images with and without occlusions will help to ensure a more accurate final result during the rendering operation discussed below. The sample images 504, 506, 508 are used to train the diffusion model utilized by the augmented reality eyewear evaluator 104 for removing any existing occlusions on the user's facial region depicted in the target image.

Referring back to the system diagram of FIG. 1, the generative model component 108 is executed by the processor of the computing device 102 to apply a diffusion model in instances where the target image of the user depicts an object occluding a portion of the user's face. The diffusion model is trained using the sample images obtained and/or generated by the image sampler 106. During training of the diffusion model, Gaussian noise is successively inserted into each sample image. The diffusion model then undergoes learning by denoising the sample image.

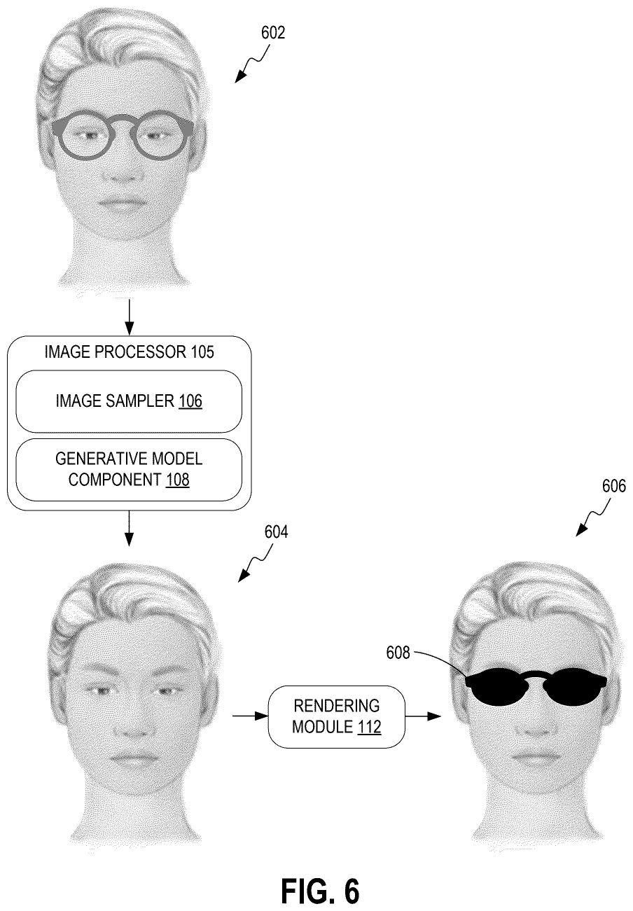

To illustrate, reference is made to FIG. 6, which illustrates processing of a target image 602, whereby an occlusion is removed and desired eyewear is then rendered on the modified target image 604 to generate a final image 606. To begin, the image sampler 106 obtains a target image 602 depicting a facial region of the user. In the example shown, the user is wearing glasses when an image of the user is captured by the image sampler 106. Assume for purposes of illustration that the image sampler 106 has already accumulated sample images 502 (FIG. 5) of the same user, where some of the sample images depict occlusions on the facial region of the user while other sample images do not depict any occlusions on the facial region of the user. To expand dataset diversity of the sample images 502 (FIG. 5), the image sampler 106 generates additional sample images based on the sample images 504, 506, 508.

As discussed above, the diffusion model is trained using the sample images obtained and/or generated by the image sampler 106. During training of the diffusion model, Gaussian noise is successively inserted into each sample image. The diffusion model then undergoes learning by denoising the sample image. This learned denoising process is then utilized by the generative model component 108 to remove the original occlusion from view. Referring back to the example shown in FIG. 6, a modified target image 604 is generated whereby the glasses originally worn by the user in the target image 602 has been removed. The rendering module 112 is executed to render a final image 606 with the selected eyewear 608 now superimposed on the facial region of the user.

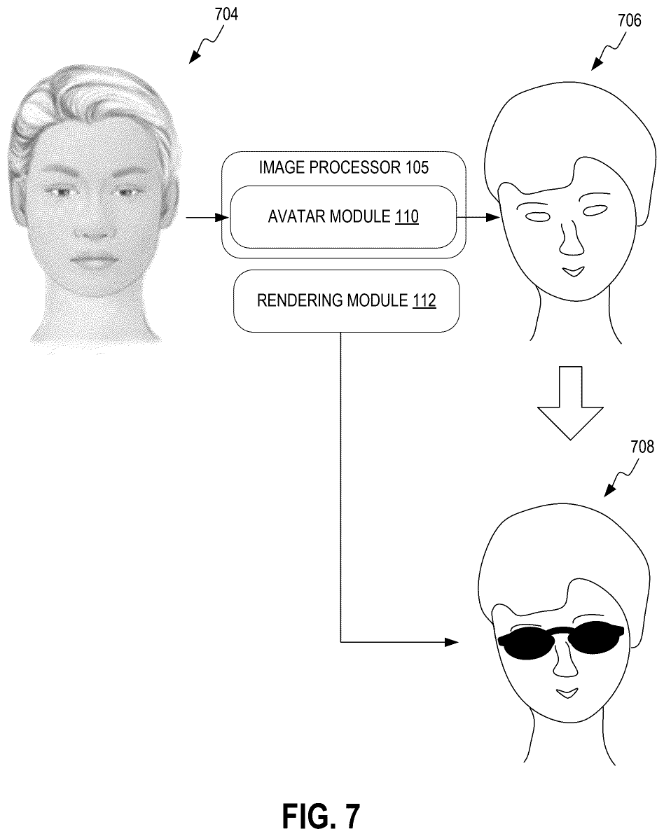

FIG. 7 illustrates the rendering module 112 rendering a final image 708 with the selected eyewear superimposed on the facial region of an avatar of the user. In some embodiments, the image processor 105 in FIG. 1 includes an avatar module 110 configured to receive the target image 604 (FIG. 6) whereby any occlusions originally depicted in the target image are removed. The avatar module 110 applies facial landmark detection to the facial region of the user depicted in the target image 704 and applies a 3D reconstruction algorithm to generate a 3D avatar 706 of the user. The rendering module 112 then renders the selected eyewear on the 3D avatar 706 to generate a final image 708.

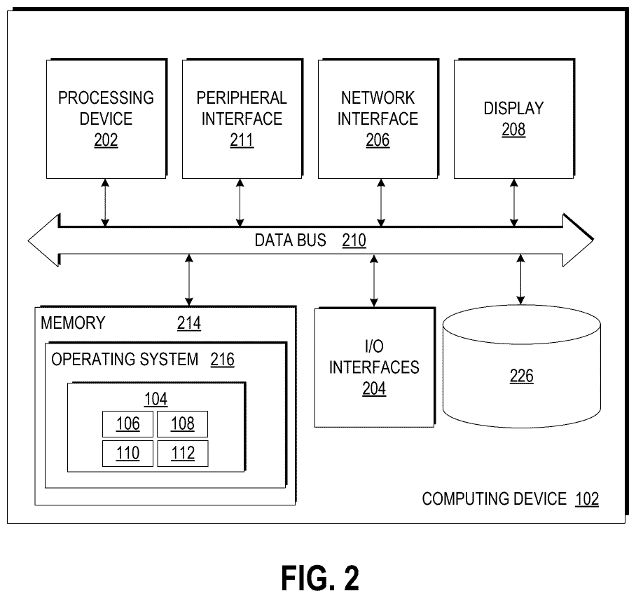

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

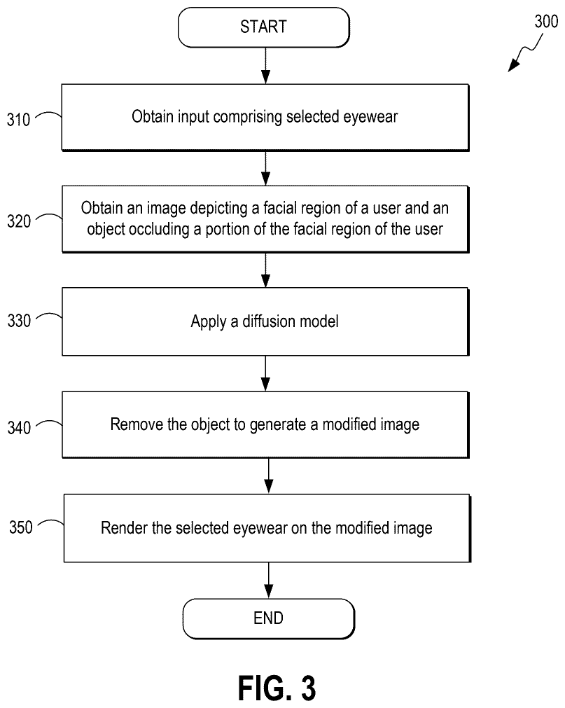

Reference is made to FIG. 3, which is a flowchart 300 in accordance with various embodiments for implementing an augmented reality service for performing virtual fitting of eyewear, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 obtains input comprising selected eyewear. At block 320, the computing device 102 obtains an image depicting a facial region of a user and an object occluding a portion of the facial region of the user. For some embodiments, computing device 102 also obtains sample images depicting the facial region of the user, where at least some of the sample images do not depict any object occluding a portion of the facial region of the user. The computing device 102 trains the diffusion model using each of the sample images. To facilitate training of the diffusion model, the computing device 102 may expand dataset diversity of the sample images by performing image enhancement on another portion of the sample images. This comprises performing such operations as rotating the facial region of the user, performing translation on the facial region of the user, scaling the facial region of the user, and/or inserting an object occluding a portion of the facial region of the user.

At block 330, the computing device 102 applies a diffusion model. At block 340, the computing device 102 removes the object to generate a modified image. At block 350, the computing device 102 renders the selected eyewear on the modified image. For alternative embodiments, the computing device 102 renders the selected the eyewear on a three-dimensional (3D) avatar of the user. For these embodiments, the computing device 102 generates the 3D avatar of the user by applying facial landmark detection to the facial region of the user depicted in the image and applies a 3D reconstruction algorithm to generate the 3D avatar.

For some embodiments, the computing device 102 obtains not only an image of the user but also obtains textual input specifying a desired background setting for the modified image. The computing device 102 renders a background in the modified image based on the specified background setting. Thereafter, the process in FIG. 3 ends.

In accordance with other embodiments, the image sampler 106 in the system diagram of FIG. 1 is configured to obtain a first image depicting a facial region of a user and an object occluding a portion of the facial region of the user. The object may comprise glasses worn by the user, a raised hand, and so on. The generative model component 108 is configured to process the first image and generate a second image of the user, where the second image depicts the image without the object occluding the portion of the facial region of the user. The user may then select a desired pair of eyeglasses to try on, where the image processor 105 in FIG. 1 obtains the selection comprising the desired eyeglasses. The rendering module 112 then generates a third image comprising the desired eyeglasses rendered on the second image to perform virtual try-on of the desired eyeglasses, thereby allowing the user to try on desired eyeglasses even when the user is wearing another pair of eyeglasses.

In accordance with other embodiments, the augmented reality eyewear evaluator 104 in FIG. 1 allows the user to capture a live video of the user and allow the user to evaluate desired eyeglasses on a three-dimensional (3D) avatar of the user generated by the augmented reality eyewear evaluator 104. Embodiments relating to generation of a 3D avatar for evaluating eyeglasses are now described in connection with the components shown in the system diagram of FIG. 1. For embodiments directed to 3D avatars, the image sampler 106 obtains a live video of the user using, for example, a front-facing camera, as illustrated in the implementation depicted in FIG. 4. The image sampler 106 obtains a first frame from the live video, where the first frame depicts a facial region of the user and an object occluding a portion of the facial region of the user. The object may comprise eyeglasses worn by the user, a hand over the facial region, and so on.

The generative model component 108 processes the first frame and generates a first image that depicts the user without the object occluding the portion of the facial region of the user. The avatar module 110 then generates a first 3D avatar of the user using an AI model based on the first image. For some embodiments, the avatar module 110 generates the first 3D avatar of the user by applying facial landmark detection to the facial region of the user and applying a 3D reconstruction algorithm to generate the first 3D avatar.

The user selects a pair of eyeglasses of interest to try on, and the image processor 105 in FIG. 1 obtains the selection comprising the desired eyeglasses. The avatar module 110 merges the desired eyeglasses and the first 3D avatar to generate a second 3D avatar. For some embodiments, the merging operation performed by the avatar module 110 is based on the use of one or more predefined anchor point, where the predefined anchor points comprise locations on the facial region of the user and where portions of the desired eyeglasses come in contact with the facial region of the user.

Next, for each of the frames subsequent to the first frame of the live video, the rendering module 112 performs the following operations. The rendering module 112 tracks a pose of the user depicted in the frames and transforms the second 3D avatar to depict the pose of the head of the user. Transformation of the second 3D avatar may comprise a combination of rotation and translation operations performed on the second 3D avatar. Transformation of the second 3D avatar may also comprise adjusting a facial region of the second 3D avatar to match a facial expression of the user depicted in the live video. The second 3D avatar is displayed to the user where the second 3D avatar is wearing the desired eyeglasses and matches of the pose of the user in real time. In addition to displaying the second 3D avatar to the user, the rendering module 112 may also display a background comprising either a background specified by the user or a default background. Note that the frames subsequent to the first frame are not limited to frames that immediately follow the first frame. Furthermore, for some embodiments, the user selects the first frame and uploads the first frame to the image sampler 106 in FIG. 1.

Another embodiment is now described where the augmented reality eyewear evaluator 104 in FIG. 1 captures a live video of the user and allows the user to evaluate desired eyeglasses on a 3D avatar of the user. In this embodiment, the image sampler 106 obtains a live video of the user using, for example, a front-facing camera, as illustrated in the implementation depicted in FIG. 4. The image sampler 106 obtains a first frame from the live video, where the first frame is specified by the user, and where the first frame depicts a facial region of the user. The avatar module 110 (FIG. 1) generates a 3D avatar of the user using an AI model based on the first frame.

The user selects a pair of eyeglasses of interest to try on, and the image processor 105 in FIG. 1 obtains the selection comprising the desired eyeglasses. Next, for each of the frames subsequent to the first frame of the live video, the rendering module 112 performs the following operations. The rendering module 112 tracks a pose of user's head, and transforms the 3D avatar wearing the desired eyeglasses to depict the user's current pose. The 3D avatar and the desired eyeglasses are displayed to the user to facilitate evaluation of the desired eyeglasses.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are included herein within the scope of this disclosure and protected by the following claims.

At least the following is claimed:

1. A method implemented in a computing device for performing virtual try-on (VTO) of eyeglasses incorporating artificial intelligence (AI) image generation, comprising:
obtaining a first image depicting a facial region of a user and an object occluding a portion of the facial region of the user; and
generating a second image of the user without the object occluding the portion of the facial region of the user based on the first image;
obtaining a selection comprising desired eyeglasses;
generating a third image comprising the desired eyeglasses rendered on the second image to perform virtual try-on of the desired eyeglasses.

2. A method implemented in a computing device for performing virtual try-on (VTO) of eyeglasses incorporating artificial intelligence (AI) image generation, comprising:
obtaining a live video;
obtaining a first frame from the live video, the first frame depicting a facial region of a user and an object occluding a portion of the facial region of the user;
generating a first image of the user without the object occluding the portion of the facial region of the user based on the first frame;
generating a first three-dimensional (3D) avatar of the user using an artificial intelligence (AI) model based on the first image;
obtaining a selection comprising desired eyeglasses;
merging the desired eyeglasses and the first 3D avatar to generate a second 3D avatar; and
in frames subsequent to the first frame of the live video, performing the steps of:
tracking a pose of head of the user;
transforming the second 3D avatar to depict the pose of the head; and
displaying the second 3D avatar.

3. The method of claim 2, wherein generating the first 3D avatar of the user comprises:
applying facial landmark detection to the facial region of the user; and
applying a 3D reconstruction algorithm to generate the first 3D avatar.

4. The method of claim 2, wherein the user selects the first frame from the live video, and wherein the first frame from the live video is uploaded by the user.

5. The method of claim 2, wherein merging the desired eyeglasses and the first 3D avatar is performed based on at least one predefined anchor point.

6. The method of claim 2, wherein transforming the second 3D avatar to depict the pose of the head comprises performing rotation and translation operations on the second 3D avatar.

7. The method of claim 2, wherein displaying the second 3D avatar comprises displaying the 3D avatar with a background, wherein the background comprises one of: a background uploaded by the user, or a default background.

8. The method of claim 2, wherein displaying the second 3D avatar comprises applying a deformation operation to the second 3D avatar to match an expression of the user depicted in the live video.

9. A method implemented in a computing device for performing virtual try-on (VTO) of eyeglasses incorporating artificial intelligence (AI) image generation, comprising:
obtaining a live video;
obtaining a first frame from the live video, the first frame depicting a facial region of a user;
generating a three-dimensional (3D) avatar of the user using an artificial intelligence (AI) model based on the first frame;
obtaining a selection comprising desired eyeglasses; and
in frames subsequent to the first frame of the live video, performing the steps of:
tracking a pose of a head of the user;
transforming the 3D avatar and the desired eyeglasses to depict the pose of the head; and
displaying the 3D avatar and the desired eyeglasses.

10. A system, comprising:
a memory storing instructions;
a processor coupled to the memory and configured by the instructions to at least:
obtain a live video;
obtain a first frame from the live video, the first frame depicting a facial region of a user and an object occluding a portion of the facial region of the user;
generate a first image of the user without the object occluding the portion of the facial region of the user based on the first frame;
generate a first three-dimensional (3D) avatar of the user using an artificial intelligence (AI) model based on the first image;
obtain a selection comprising desired eyeglasses;
merge the desired eyeglasses and the first 3D avatar to generate a second 3D avatar; and
in frames subsequent to the first frame of the live video, performing the steps of:
track a pose of head of the user;
transform the second 3D avatar to depict the pose of the head; and
display the second 3D avatar.

11. The system of claim 10, wherein the processor is configured to generate the first 3D avatar of the user by:
applying facial landmark detection to the facial region of the user; and
applying a 3D reconstruction algorithm to generate the first 3D avatar.

12. The system of claim 10, wherein the user selects the first frame from the live video, and wherein the first frame from the live video is uploaded by the user.

13. The system of claim 10, wherein the processor is configured to merge the desired eyeglasses and the first 3D avatar based on at least one predefined anchor point.

14. The system of claim 10, wherein the processor is configured to transform the second 3D avatar to depict the pose of the head by performing rotation and translation operations on the second 3D avatar.

15. The system of claim 10, wherein the processor is configured to display the second 3D avatar by displaying the 3D avatar with a background, wherein the background comprises one of: a background uploaded by the user, or a default background.

16. The system of claim 10, wherein the processor is configured to display the second 3D avatar by applying a deformation operation to the second 3D avatar to match an expression of the user depicted in the live video.

17. A non-transitory computer-readable storage medium storing instructions to be implemented by a computing device having a processor, wherein the instructions, when executed by the processor, cause the computing device to at least:
obtain a live video;
obtain a first frame from the live video, the first frame depicting a facial region of a user and an object occluding a portion of the facial region of the user;
generate a first image of the user without the object occluding the portion of the facial region of the user based on the first frame;
generate a first three-dimensional (3D) avatar of the user using an artificial intelligence (AI) model based on the first image;
obtain a selection comprising desired eyeglasses;
merge the desired eyeglasses and the first 3D avatar to generate a second 3D avatar; and
in frames subsequent to the first frame of the live video, performing the steps of:
track a pose of head of the user;
transform the second 3D avatar to depict the pose of the head; and
display the second 3D avatar.

18. The non-transitory computer-readable storage medium of claim 17,
wherein the processor is configured by the instructions to generate the first 3D avatar of the user by:
applying facial landmark detection to the facial region of the user; and
applying a 3D reconstruction algorithm to generate the first 3D avatar

19. The non-transitory computer-readable storage medium of claim 17, wherein the user selects the first frame from the live video, and wherein the first frame from the live video is uploaded by the user.

20. The non-transitory computer-readable storage medium of claim 17, wherein the processor is configured by the instructions to transform the second 3D avatar to depict the pose of the head by performing rotation and translation operations on the second 3D avatar.
